(19) United States
(12) Patent Application Publication
(10) Pub. No.: US 2013/0305163 A1
(43) Pub. Date: Nov. 14, 2013

(54) Screen and Associated File Sharing

(71) Applicants: Ryan Farmer, Redmond, WA (US); Xingzhao Liu, Bellevue, WA (US); Felix Wong, Bellevue, WA (US); John H. Zybura, Seattle, WA (US); Nadia Marie Wanamaker, Sammamish, WA (US)

(72) Inventors: Ryan Farmer, Redmond, WA (US); Xingzhao Liu, Bellevue, WA (US); Felix Wong, Bellevue, WA (US); John H. Zybura, Seattle, WA (US); Nadia Marie Wanamaker, Sammamish, WA (US)

(73) Assignee: MICROSOFT CORPORATION, Redmond, WA (US)

(21) Appl. No.: 13/467,373

(22) Filed: May 9, 2012

(51) Int. Cl. G06F 15/16

(52) U.S. Cl. 715/748

(57) ABSTRACT

Sharing files associated with an application screen is provided. A selection of a user interface window may be received on a computer. The user interface may include a view of a file previously opened by an application generating the user interface window. The user interface window including the view of the previously opened file may be shared by the computer with one or more viewers. The computer may then share the previously open file with the one or more viewers while continuing to share the user interface window. The computer may choose to represent the view in any way and associate with the file (i.e., backing data) to be rendered in an alternative way.

### COPYRIGHT NOTICE

A portion of the disclosure of this patent document may contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Online or web conferencing applications support the sharing of a user's screen as a means of providing access to various applications to other conference participants. For example, during a web conferencing session, a conference participant may open a word processing application on her computer screen in order to display and share a relevant portion of a word processing document with other participants on their respective computer screens. Additionally, some web conferencing applications support the sending of individual files to others. For example, following a web conferencing session, a participant may utilize a web conferencing application to send a word processing file related to a portion of a document displayed within a previously shared of a word processing application. In this manner, the conference participants may have access to and view the entire file associated with the displayed document. However, current web conferencing applications also suffer from a number of limitations. For example, while these applications support functionality for both the individual sharing of applications and file transfer, they fail to provide these concepts in a unified manner. In particular, current web conferencing applications require separate processes for application sharing and file transfer. As a result, users must undergo one set of steps to share an application and a separate and distinct set of steps to transfer files. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for sharing files associated with an application screen. A selection of an application instance view may be received on a computer. The application instance view may include a view of a file previously opened by an application generating the application instance view. The application instance view including the view of the previously opened file may be shared by the computer with one or more viewers. The computer may then share the previously open file with the one or more viewers while continuing to share the application instance view. These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a computing environment which may be utilized for sharing files associated with an application screen, in accordance with an embodiment;

FIG. 2 is a computer screen display of a user interface for selecting application instance views for sharing with one or more viewers and for sharing an associated file, in accordance with an embodiment;

FIG. 3 is a computer screen display of a user interface for viewing a selected application instance view and for sharing an associated file, in accordance with an embodiment;

FIG. 4 is a computer screen display of a user interface for viewing a shared application instance view and for saving an associated shared file, in accordance with an embodiment;

FIG. 5 is a flow diagram illustrating a routine for sharing files associated with an application screen, in accordance with an embodiment;

FIG. 6 is a simplified block diagram of a computing device with which various embodiments may be practiced;

FIG. 7A is a simplified block diagram of a mobile computing device with which various embodiments may be practiced; and

FIG. 7B is a simplified block diagram of a mobile computing device with which various embodiments may be practiced.

### DETAILED DESCRIPTION

Embodiments are provided for sharing files associated with an application screen. A selection of an application instance view may be received on a computer. The application instance view may include a view of a file previously opened by an application generating the application instance view. The application instance view including the view of the previously opened file may be shared by the computer with one or more viewers. The computer may then share the previously open file with the one or more viewers while continuing to share the application instance view.

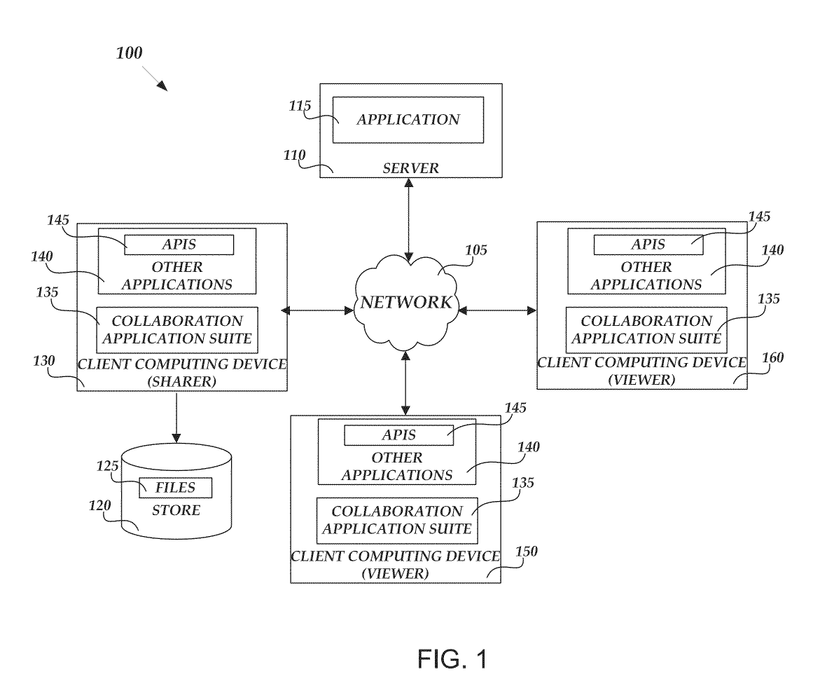

FIG. 1 is a block diagram illustrating a distributed computing environment 100 which may be utilized for sharing files associated with an application screen, in accordance with an embodiment. The distributed computing environment 100 includes a server 110 which is in communication with client computing devices 130, 150 and 160 over a network 4 which may comprise, for example, a local network or a wide area network (e.g., the Internet). The server 110 may store an application 115 for facilitating collaborative communications between the client computing devices 130, 150 and 160. In particular, the application 115 may support the sharing of desktops, monitors or individual applications (via process, window, or screen region) between the client computing devices 130, 150 and 160. Additionally, the application 115 may also support file transfer (i.e., the ability for users to exchange documents between two or more users) between the aforementioned computing devices. In accordance with an embodiment, the application 115 may comprise a unified communications platform which may include, but is not limited to, functionality for instant messaging, presence, file transfer, peer-to-peer and multiparty voice and video calling, ad hoc and structured conferences (audio, video and web) and public switched telephone network (“PSTN) connectivity. An illustrative unified communications platform which may be utilized with the various embodiments described herein is the LYNC SERVER enterprise-ready unified communications platform software from MICROSOFT CORPORATION of Redmond, Wash. It should be understood, however, that other communications platform software from other manufacturers may alternatively be utilized in accordance with the various embodiments described herein.

It should be understood that the client computing devices 130, 150 and 160 may comprise any of a number of devices including, without limitation, desktop computing devices as well as laptop, tablet or other mobile computing devices. In accordance with an embodiment, the client computing devices 130, 150 and 160 may serve different user roles in association with the screen and associated file sharing functionality described herein. In particular, the client computing device 130 may serve as a “sharer” of application screens and associated files while the client computing devices 150 and 160 may serve as the “viewers” of the same application screens and associated files. In particular, the client computing device 130 may be in communication with a data store 120 which stores files 125 for sharing with the client computing devices 150 and 160. It should be understood, that as defined herein, the files 125 may include backing data that may be shared. The client computing devices 130, 150 and 160 may each store a collaboration application suite 135 which, in conjunction with the application 115 on the server 110, supports screen and associated file sharing between the client computing devices 130, 150 and 160. The collaboration application suite 135 may be associated with a number of other applications 140. The other applications 140 may be utilized for opening, viewing and saving files (e.g., the files 125 in the data store 120) on the client computing devices 130, 150 and 160. The other applications 140 may include associated application programming interfaces (“APIs”) 150. In particular, and as will be described in greater detail herein, the APIs 150 may utilized to determine a document path for a shared application to facilitate the transfer of an associated file to one or more viewers. In accordance with an embodiment, the collaboration application suite may comprise the OFFICE application program suite incorporating the LYNC client communications platform from MICROSOFT CORPORATION. The other applications 140 may comprise various productivity applications for the utilized for the creation, opening, viewing and saving of files, For example, in accordance with an embodiment, the other applications 140 may comprise the WORD word processing software, POWERPOINT presentation graphics software, EXCEL spreadsheet software, VISIO diagramming software, PROJECT project management software, PUBLISHER publishing software, OUTLOOK personal information management software and the ONENOTE note-taking software from MICROSOFT CORPORATION of Redmond Wash. It should be understood that the other applications 140 are not limited to productivity applications and that other application types may also be utilized in accordance with the various embodiments described herein. It should be further understood, however, that other collaboration application suites and/or application programs from other manufacturers may be utilized in accordance with the various embodiments described herein. It should be further understood that while the above computing environment is described as a client-server distributed computing environment, the embodiments described herein are not so limited. Thus, for example, various embodiments may alternatively be implemented in a peer-to-peer client computing device configuration in which two or more client computing devices may communicate directly with each other without a server being present. In other embodiments, an intermediate server may also be utilized in conjunction with a primary server and client computing devices.

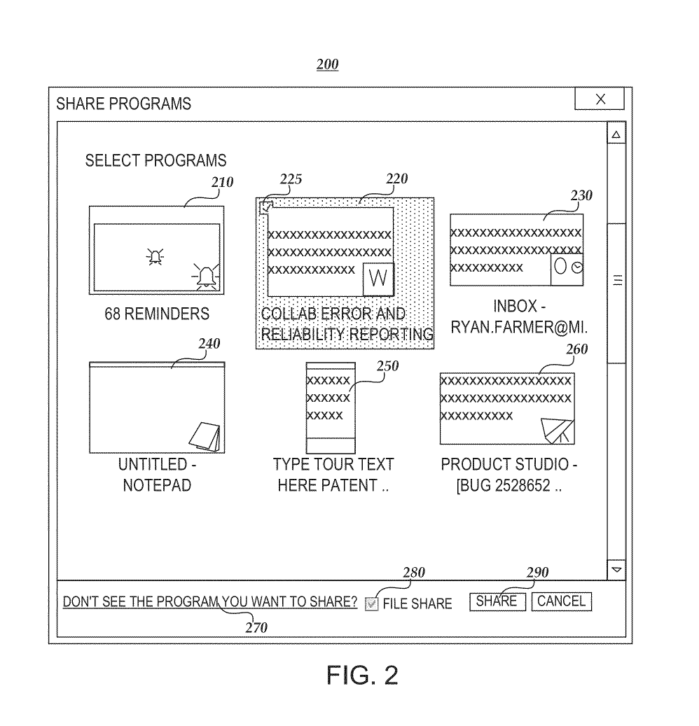

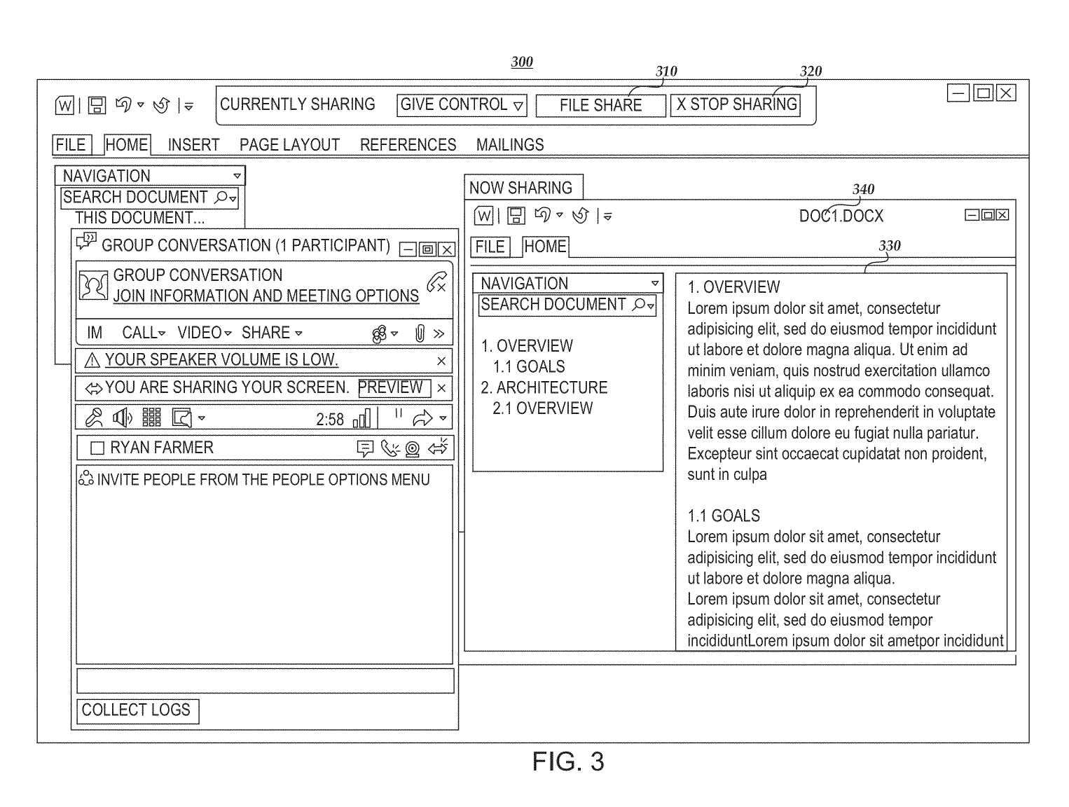

FIG. 2 is a computer screen display of a user interface 200 for selecting application instance views (i.e., application windows) for sharing with one or more viewers and for sharing an associated file, in accordance with an embodiment. The user interface 200, which may be generated by the collaboration application suite 135 on the client computing device 130 (i.e., the sharer) of FIG. 1, includes application windows 210, 220, 230, 240, 250 and 260 for choosing various applications to share with the client computing devices 150 and 160 (i.e., the viewers). In particular, the application windows 210, 220, 230, 240, 250 and 260 may comprise screen displays of currently open application files for sharing with one or more viewers. For example, the application window 210 shows an open reminder file in a personal information management application, the application window 220 shows an open word processing file in a word processing application, the application window 230 shows an open e-mail file in an e-mail application, the application window 240 shows an open notepad file in a notepad application, the application window 250 shows an open text file in a text application and the application window 260 shows an open code file in a developer application. The application window 220 further shows a checkbox 225 indicating that the displayed application screen has been chosen by the sharer (the application window 225 may also shown as shaded to distinguish the selected application window 225 from non-selected application windows in the user interface 200). The user interface 200 further includes various user controls which are associated with application screen and file sharing in accordance with an embodiment. In particular, link 270 may be utilized for selecting additional applications to share, file share checkbox 280 may be utilized for sharing the files associated with one or more selected applications windows and share button 290 may be utilized for viewing one or more selected application windows. It should be understood, than in accordance with an embodiment, multiple application windows may be selected for simultaneous sharing from within the user interface 200. It should further be understood that in accordance with the aforementioned embodiment, the subsequent selection of the file share checkbox 280 will cause multiple files, which are associated with the multiple application windows, to also be shared. It should be further understood that in accordance with an alternative embodiment, the user interface 200 may not include the file share checkbox 280. Instead, the sharer may be presented with the option to share files in a subsequent user interface generated after the selection of an application window. An illustrative user interface in accordance with this embodiment will be described in greater detail below with respect to FIG. 3.

FIG. 3 is a computer screen display of a user interface 300 for viewing a selected application instance view (i.e., application window) and for sharing an associated file, in accordance with an embodiment. The user interface 300, which may be generated by the collaboration application suite 135 on the client computing device 130 (i.e., the sharer) of FIG. 1, includes a selected application window 330 having application title 340, which is being displayed during a collaborative communication session (e.g., a web conference). The user interface 300 further includes a File Share button 310 to share the file associated with the selected application window 330 with one or more viewers (e.g., by uploading the file to the client computing devices 150 and 160 of FIG. 1). The user interface 300 further includes a Stop Sharing button 320 for terminating a sharing session associated with the application title 340. Thus, the application associated with the application title 340 would still exist even although it would no longer be visible to the one or more viewers.

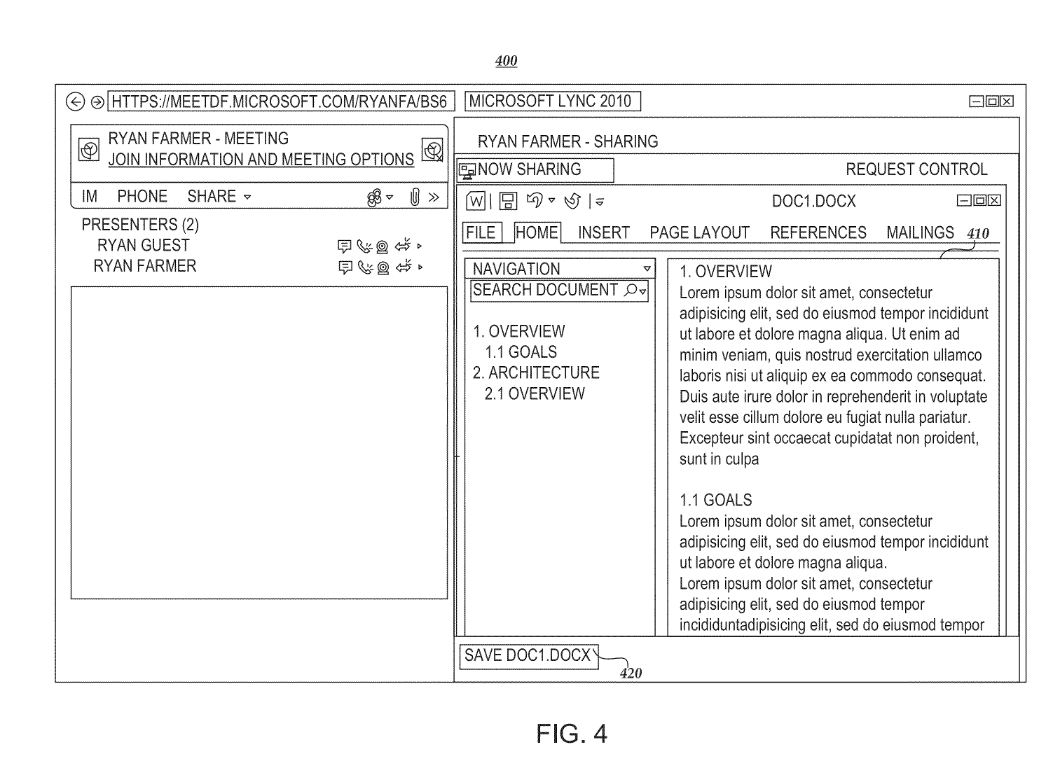

FIG. 4 is a computer screen display of a user interface 400 for viewing a shared application instance view (i.e., application window) and for saving an associated shared file, in accordance with an embodiment. The user interface 400, which may be generated by the collaboration application suite 135 on the client computing devices 150 and 160 (i.e., the viewers) of FIG. 1, includes a shared application window 410 previously selected by a sharer (e.g., the client computing device 130 of FIG. 1). The user interface 400 further includes a Save button 420 for saving the file associated with the displayed shared application window 410 on a viewer's computer, the file having also been previously transferred by the sharer.

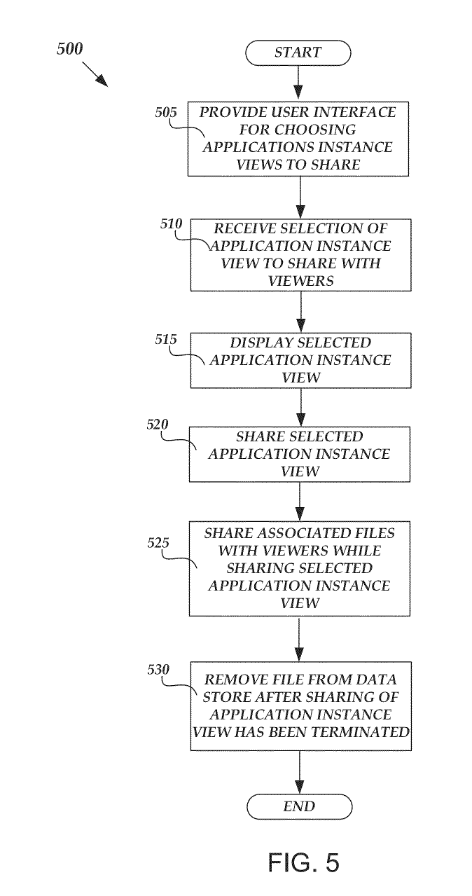

FIG. 5 is a flow diagram illustrating a routine 500 for sharing files associated with an application screen, in accordance with an embodiment. When reading the discussion of the routine presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 5 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 500 begins at operation 505, where the collaborative application suite 135, executing on the client computing device 130, provides a user interface for choosing applications instance views to share with one or more viewers. It should be understood that prior to the user interface being provided, the client computing device 130 (i.e., the sharer) may associate one or more application instance views with one or more files. The user interface may display multiple distinct application instance views. For example, the collaborative application suite 135 may generate the user interface 200 discussed above with respect to FIG. 2. Each of the application instance views in the displayed user interface may comprise a view of a file previously opened by an associated application.

From operation 505, the 500 continues to operation 510, where the collaborative application suite 135, executing on the client computing device 130, receives a selection of an application instance view to share with one or more viewers. In accordance with an alternative embodiment, multiple application instance views may be selected for sharing with the one or more viewers.

From operation 510, the routine 500 continues to operation 515, where the collaborative application suite 135, executing on the client computing device 130, displays the application instance view selected at operation 505.

From operation 515, the routine 500 continues to operation 520, where the collaborative application suite 135, executing on the client computing device 130, shares the selected application instance view with one or more viewers. For example, a user of the collaborative application suite 135 may utilize the user interface 300 discussed above with respect to FIG. 3 to share the selected application instance view with one or more viewers in a web conference session.

From operation 520, the routine 500 continues to operation 525, where the collaborative application suite 135, executing on the client computing device 130, shares a file associated with the selected application instance view while the selected application window is being shared with one or more viewers. In particular, the collaboration application suite 135 may: (1) receive a command in a user interface to share the file with the one or more viewers; (2) call a process to determine a document path for accessing the file; and (3) upload the file to the one or more viewers. In accordance with an embodiment, the command to share the file may be received when selecting the application instance view to share with one or more viewers, as described above at operation 510. In accordance with an alternative embodiment, the command to share the file may be received from the user interface 300 after initiating the sharing of the selected application instance view with one or more viewers in a web conference session, as described above at operation 520. The document path for accessing the file may be determined by calling an API which provides information as to the identity of a file currently being viewed in the selected application instance view. It should be understood that the called API may apply to either an application or an operating system. For example, an API may be called which requests the operating system on a client computing device for the title of the selected application instance view and determines the identity of the associated file based on this request. It should be understood, however, that the embodiments described herein are not limited to the use of APIs and that other methods, known to those skilled in the art, may also be utilized to determine a document path for accessing the aforementioned file. It should be further understood that the sharing of the file with one or more viewers may include sharing a title of the application associated with the file.

From operation 525, the routine 500 continues to operation 530, where the collaborative application suite 135, executing on the client computing device 130, removes the file from a data store after the sharing of the application instance view associated with the file has been terminated. In particular, once an application is stopped from sharing, the file may be removed or deleted. It should be further be understood that, in accordance with another embodiment, the file may not be removed but rather may be saved and associated with the fact that a user has shared the file at some point in time. It should further be understood that the aforementioned operation 530 is optional and thus is not required with respect to the routine 500 described herein. For example, in accordance with another embodiment, the file may be kept in the data store with a history that a user shared the application. From operation 530, the routine 500 then ends.

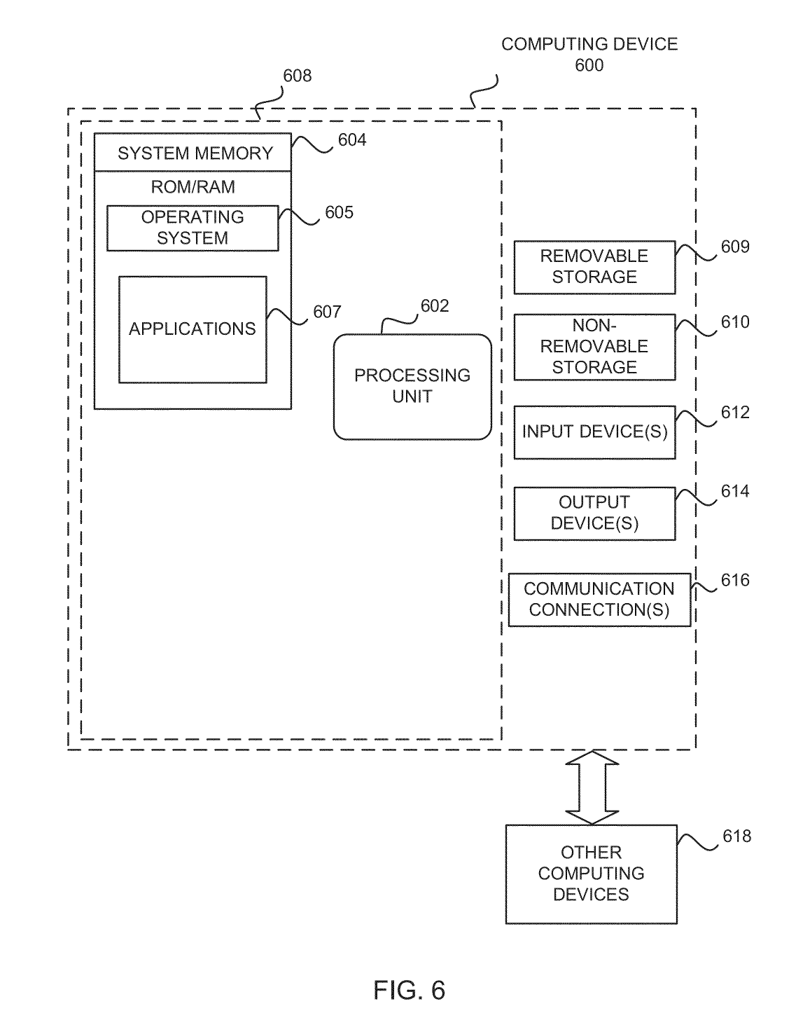

FIG. 6 is a block diagram illustrating example physical components of a computing device 600 with which various embodiments may be practiced. The computing device components described below may be suitable for the server 110 and the client computing devices 130, 150 and 160 described above with respect to FIG. 1. In a basic configuration, the computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include an operating system 605 and applications 607. Operating system 605, for example, may be suitable for controlling computing device 600's operation and, in accordance with an embodiment, may comprise the WINDOWS operating systems from MICROSOFT CORPORATION of Redmond, Wash. It should be understood that the embodiments described herein may also be practiced in conjunction with other operating systems and application programs and further, is not limited to any particular application or system.

The computing device 600 may have additional features or functionality. For example, the computing device 600 may also include additional data storage devices (removable and/or non-removable) such as, for example, magnetic disks, optical disks, solid state storage devices (“SSD”), flash memory or tape. Such additional storage is illustrated in FIG. 6 by a removable storage 609 and a non-removable storage 610.

Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 600 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 600. Any such computer storage media may be part of the computing device 600. The computing device 600 may also have input device(s) 612 such as a keyboard, a mouse, a pen, a sound input device (e.g., a microphone), a touch input device, etc. Output device(s) 614 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

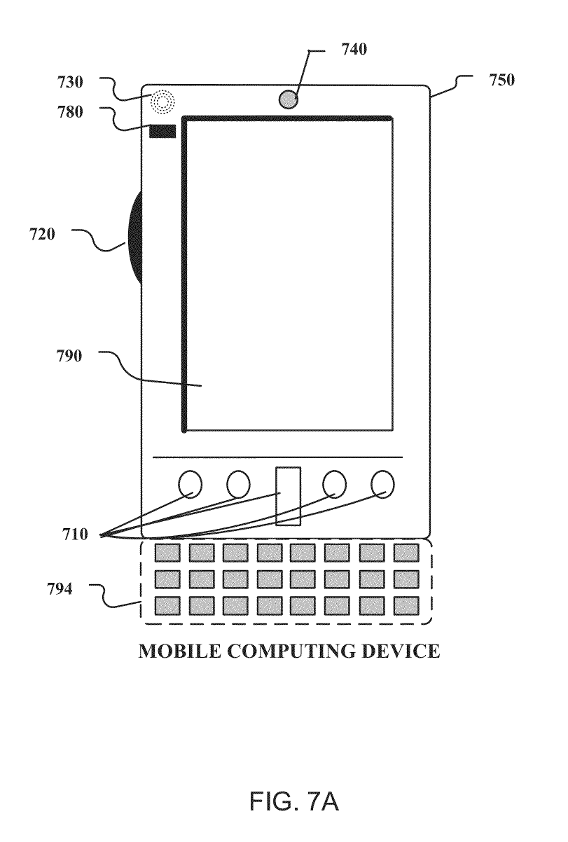

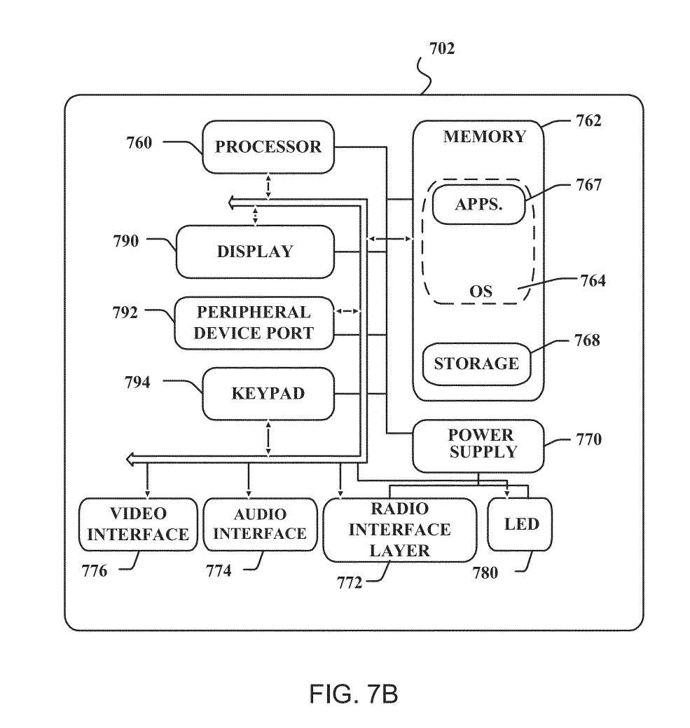

FIGS. 7A and 7B illustrate a suitable mobile computing environment, for example, a mobile computing device 750 which may include, without limitation, a smartphone, a tablet personal computer, a laptop computer, and the like, with which various embodiments may be practiced. With reference to FIG. 7A, an example mobile computing device 750 for implementing the embodiments is illustrated. In a basic configuration, mobile computing device 750 is a handheld computer having both input elements and output elements. Input elements may include touch screen display 725 and input buttons 710 that allow the user to enter information into mobile computing device 750. Mobile computing device 750 may also incorporate an optional side input element 720 allowing further user input. Optional side input element 720 may be a rotary switch, a button, or any other type of manual input element. In alternative embodiments, mobile computing device 750 may incorporate more or less input elements. For example, display 725 may not be a touch screen in some embodiments. In yet another alternative embodiment, the mobile computing device is a portable telephone system, such as a cellular phone having display 725 and input buttons 710. Mobile computing device 750 may also include an optional keypad 705. Optional keypad 705 may be a physical keypad or a “soft” keypad generated on the touch screen display.

Mobile computing device 750 incorporates output elements, such as display 725, which can display a graphical user interface (GUI). Other output elements include speaker 730 and LED light 726. Additionally, mobile computing device 750 may incorporate a vibration module (not shown), which causes mobile computing device 750 to vibrate to notify the user of an event. In yet another embodiment, mobile computing device 750 may incorporate a headphone jack (not shown) for providing another means of providing output signals.

Although described herein in combination with mobile computing device 750, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 7B is a block diagram illustrating components of a mobile computing device used in one embodiment, such as the mobile computing device 750 shown in FIG. 7A. That is, mobile computing device 750 can incorporate a system 702 to implement some embodiments. For example, system 702 can be used in implementing a “smart phone” that can run one or more applications similar to those of a desktop or notebook computer. In some embodiments, the system 702 is integrated as a computing device, such as an integrated personal digital assistant (PDA) and wireless phone.

Applications 767 may be loaded into memory 762 and run on or in association with an operating system 764. The system 702 also includes non-volatile storage 768 within memory the 762. Non-volatile storage 768 may be used to store persistent information that should not be lost if system 702 is powered down. The applications 767 may use and store information in the non-volatile storage 768. A synchronization application (not shown) also resides on system 702 and is programmed to interact with a corresponding synchronization application resident on a host computer to keep the information stored in the non-volatile storage 768 synchronized with corresponding information stored at the host computer. As should be appreciated, other applications may also be loaded into the memory 762 and run on the mobile computing device 750.

The system 702 has a power supply 770, which may be implemented as one or more batteries. The power supply 770 might further include an external power source, such as an AC adapter or a powered docking cradle that supplements or recharges the batteries.

The system 702 may also include a radio 772 (i.e., radio interface layer) that performs the function of transmitting and receiving radio frequency communications. The radio 772 facilitates wireless connectivity between the system 702 and the “outside world,” via a communications carrier or service provider. Transmissions to and from the radio 772 are conducted under control of OS 764. In other words, communications received by the radio 772 may be disseminated to the applications 767 via OS 764, and vice versa.

The radio 772 allows the system 702 to communicate with other computing devices, such as over a network. The radio 772 is one example of communication media. The embodiment of the system 702 is shown with two types of notification output devices: an LED 780 that can be used to provide visual notifications and an audio interface 774 that can be used with speaker 730 to provide audio notifications. These devices may be directly coupled to the power supply 770 so that when activated, they remain on for a duration dictated by the notification mechanism even though processor 760 and other components might shut down for conserving battery power. The LED 780 may be programmed to remain on indefinitely until the user takes action to indicate the powered-on status of the device. The audio interface 774 is used to provide audible signals to and receive audible signals from the user. For example, in addition to being coupled to speaker 730, the audio interface 774 may also be coupled to a microphone (not shown) to receive audible input, such as to facilitate a telephone conversation. In accordance with embodiments, the microphone may also serve as an audio sensor to facilitate control of notifications. The system 702 may further include a video interface 776 that enables an operation of on-board camera 730 to record still images, video streams, and the like.

A mobile computing device implementing the system 702 may have additional features or functionality. For example, the device may also include additional data storage devices (removable and/or non-removable) such as, magnetic disks, optical disks, or tape. Such additional storage is illustrated in FIG. 7B by storage 768.

Data/information generated or captured by the mobile computing device 750 and stored via the system 702 may be stored locally on the mobile computing device 750, as described above, or the data may be stored on any number of storage media that may be accessed by the device via the radio 772 or via a wired connection between the mobile computing device 750 and a separate computing device associated with the mobile computing device 750, for example, a server computer in a distributed computing network such as the Internet. As should be appreciated such data/information may be accessed via the mobile computing device 750 via the radio 772 or via a distributed computing network. Similarly, such data/information may be readily transferred between computing devices for storage and use according to well-known data/information transfer and storage means, including electronic mail and collaborative data/information sharing systems.

It should be understood, in accordance with the various embodiments described herein, that the association of application instance views with files is not just for speeding up the sharing of the files. For example, the above-described embodiments could be utilized for the separate viewing or even sharing of a collaborative document (e.g., viewers may co-edit a document). It should be also be understood that there are additional application of the above-described embodiments which go beyond efficiency and that backing data (i.e., files) may be associated as well as the view of the backing data. Thus, the above-described embodiments may be utilized in many different ways in addition to the saving/viewing of files. For example, the above-described embodiments may also provide for the collaborative editing of files or provide a different user interface view for viewers of a document so that the viewers can jump ahead a number of pages in the document without even thinking about the fact that a file was shared.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the embodiments described herein.

It will be apparent to those skilled in the art that various modifications or variations may be made without departing from the scope or spirit of the embodiments described herein. Other embodiments will be apparent to those skilled in the art from consideration of the specification and practice of the embodiments described herein. Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method for sharing files associated with an application screen, comprising:
associating, by a computer, an application instance view with a file, the file comprising backing data;
receiving, by the computer, a selection of the application instance view comprising a view of the file, the file being previously opened by an associated application, the application instance view being selected by a sharer of the associated application;
sharing, by the computer, the selected application instance view comprising the view of the file with one or more viewers; and
sharing, by computer, the file with the one or more viewers while sharing the selected application instance view.

2. The method of claim 1, wherein sharing, by computer, the file with the one or more viewers while sharing the selected application instance view comprises:
receiving a command to share the file with the one or more viewers;
calling, from within the application instance view, a process to determine a document path for accessing the file; and
uploading the file to the one or more viewers.

3. The method of claim 2, wherein receiving a command to share the file with the one or more viewers comprises receiving a selection of an option to share the file when receiving the selection of the application instance view.

4. The method of claim 2, wherein receiving a command to share the file with the one or more viewers comprises receiving a selection of an option to share the file from within the application instance view after sharing the application instance view with the one or more viewers.

5. The method of claim 2, wherein calling, from within the application instance view, a process to determine a document path for accessing the file comprises calling an application programming interface (API), the API providing information as to the identity of the file currently being viewed in the application instance view.

6. The method of claim 1, wherein sharing, by computer, the file with the one or more viewers while sharing the application instance view comprises sharing a title of the associated application with the one or more viewers.

7. The method of claim 1, further comprising viewing the selected application instance view comprising the view of the file.

8. The method of claim 1, further comprising removing the file from a data store after the sharing of the selected application instance view comprising the view of the file with one or more viewers has been terminated.

9. The method of claim 1, further comprising providing a user interface, the user interface comprising a plurality of distinct application instance views.

10. A computing device for sharing files, comprising:
a memory for storing executable program code; and
a processor, functionally coupled to the memory, the processor being responsive to computer-executable instructions contained in the program code and operative to:
receive a selection of an application instance view comprising a view of a file previously opened by an associated application, the application instance view being selected by a sharer of the associated application;
share the selected application instance view comprising the view of the file with one or more viewers;
share the file with the one or more viewers while sharing the selected application instance view by uploading the file to the one or more viewers, the one or more viewers comprising one or more of a client and a server; and
delete the file from a data store after the sharing of the selected application instance view comprising the view of the file with one or more viewers has been terminated.

11. The computing device of claim 10, wherein the processor, in sharing the file with the one or more viewers while sharing the selected application instance view is further operative to:
receive a command to share the file with the one or more viewers; and
call, from within the application instance view, an application programming interface (API) to determine a document path for accessing the file, the API providing information as to the identity of the file currently being viewed in the application instance view.

12. The computing device of claim 11, wherein the processor, in receiving a command to share the file with the one or more viewers comprises receiving a selection of a checkbox in a user interface comprising at least the application instance view, to share the file when receiving the selection of the application instance view.

13. The computing device of claim 11, wherein the processor, in receiving a command to share the file with the one or more viewers, is operative to receive a selection of a user interface button to share the file from within the application instance view after sharing the selected application instance view with the one or more viewers.

14. The computing device of claim 10, wherein the processor, in sharing, the file with the one or more viewers while sharing the selected application instance view, is operative to share a title of the associated application with the one or more viewers.

15. The computing device of claim 10, wherein the processor is further operative to provide the selected application instance view comprising the view of the file.

16. The computing device of claim 10, wherein the processor is further operative to provide a user interface, the user interface comprising a plurality of distinct application instance views.

17. A computer-readable medium comprising computer executable instructions which, when executed by a computer, will cause the computer to perform a method for sharing files associated with an application screen, the method comprising:
providing a user interface comprising a plurality of distinct application instance views;
receiving a selection of the plurality of application instance views, each of the plurality of application instance views comprising a view of a file previously opened by an associated application, the plurality of application instance views being selected by a sharer of the associated application;
providing the selected plurality of application instance views comprising the views of the files;
sharing the selected plurality of application instance views comprising the views of the files with a plurality of viewers;
receiving commands to share the files with the plurality of viewers;
calling, from within the selected plurality of application instance views comprising the views of the files, application programming interfaces (APIs) to determine document paths for accessing the files, the APIs providing information as to the identity of the files currently being viewed in the selected plurality of application instance views;
uploading the files to the plurality of viewers to share the files;
sending a title of the associated applications to the plurality of viewers; and
deleting the files from a data store after the sharing of the selected plurality application of user interfaces comprising the views of the files with the plurality of viewers has been terminated.

18. The computer-readable medium of claim 17, wherein uploading the files to the plurality of viewers to share the files comprises uploading the files simultaneously.

19. The computer-readable medium of claim 17, wherein receiving commands to share the files with the plurality of viewers comprises receiving a selection of an option to share the files when receiving the selection of the plurality of application instance views.

20. The computer-readable medium of claim 19, wherein receiving a selection of an option to share the files when receiving the selection of the plurality of application instance views comprises receiving a selection of a user interface checkbox.
